(19) United States
(12) Patent Application Publication
(10) Pub. No.: US 2014/0291446 A1
(43) Pub. Date: Oct. 2, 2014

(54) LAVATORY MONUMENT WITH STORAGE COMPARTMENT

(71) Applicant: C&D Zodiac, Inc., Huntington Beach, CA (US)

(72) Inventors: Edward Reams, Huntington Beach, CA (US); Glenn Swain, Redondo Beach, CA (US); Ian Geoffrey Scoley, Huntington Beach, CA (US); Nabih Najd, Huntington Beach, CA (US)

(21) Appl. No.: 14/304,262

(22) Filed: Jun. 13, 2014

Related U.S. Application Data
(63) Continuation-in-part of application No. 14/071,538, filed on Nov. 4, 2013.
(60) Provisional application No. 61/858,073, filed on Jul. 24, 2013.
(60) Provisional application No. 61/722,332, filed on Nov. 5, 2012.
(60) Provisional application No. 61/835,411, filed on Jun. 14, 2013.

(51) Int. Cl. B64D 11/02

(52) U.S. Cl. CPC B64D 11/02
USPC 244/118.5

(57) ABSTRACT

A lavatory monument assembly configured to be positioned in the interior of a vehicle. The lavatory monument assembly includes an enclosure that defines a first lavatory interior and includes at least a front wall and first and second side walls extending rearwardly from the front wall. The first lavatory interior includes a urinal positioned therein. The lavatory monument assembly also includes a first storage compartment positioned in the first lavatory interior. The first storage compartment includes a first storage door that is movable between an open position and a closed position. The front wall includes a first lavatory door that is movable between a closed and an open position and provides access to the first lavatory interior.

### CROSS REFERENCE TO RELATED APPLICATIONS

This application is a continuation-in-part of U.S. patent application Ser. No. 14/071,538, filed Nov. 4, 2013, which claims the benefit of U.S. Provisional Application No. 61/858,073 filed Jul. 24, 2013, and U.S. Provisional Application No. 61/722,332, filed Nov. 5, 2012, the entireties of which are incorporated herein by reference. This application also claims the benefit of U.S. Provisional Application No. 61/835,411 filed Jun. 14, 2013, the entirety of which is incorporated herein by reference.

### FIELD OF THE INVENTION

The present invention relates to an aircraft lavatory monument, and more particularly to an aircraft lavatory urinal that includes space for trolley storage.

### BACKGROUND OF THE INVENTION

Commercial aircraft, such as the Airbus A320 or Boeing 737 are typically constructed from modular components, the size, weight and construction of which are dictated by many considerations, including fuselage dimensions, aesthetic and safety considerations. Many of these requirements are imposed by law or regulation. Aircraft components, such as overhead storage compartments, seats, lavatories, galleys, lighting systems, etc. are all required to function within strictly confined spaces.

Prior art aircraft lavatories are typically fixed structures with a rectangular footprint. There is usually a sink, toilet, mirror, and waste container in the lavatory. It is typically surrounded by composite panel walls that can be contoured to fit the aircraft curvature. Multiple lavatories can be installed in the aircraft. See, for example, U.S. Pat. No. 6,079,669 to Hanay, et al., the entirety of which is incorporated by reference herein. The door is normally 20″ wide and can be a swinging door or a bi-fold one. The 20″ wide door makes the lavatory difficult to access with a wheelchair.

Manufacturers of aircraft are constantly refining interior aircraft designs to achieve more comfort and utility for passengers and crew within carrier-imposed restraints on cost, weight, maintenance down-time, and safety.

### SUMMARY OF THE PREFERRED EMBODIMENTS

In accordance with a first aspect of the present invention there is provided a lavatory monument assembly configured to be positioned in the interior of a vehicle. The lavatory monument assembly includes an enclosure that defines a first lavatory interior and includes at least a front wall and first and second side walls extending rearwardly from the front wall. The first lavatory interior includes a urinal positioned therein. The lavatory monument assembly also includes a first storage compartment positioned in the first lavatory interior. The first storage compartment includes a first storage door that is movable between an open position and a closed position. The front wall includes a first lavatory door that is movable between a closed and an open position and provides access to the first lavatory interior. Preferably, in the open position, the first storage door separates the first lavatory interior into a urinal space and a storage space. The storage space comprises a storage corridor and the first storage compartment. The storage corridor is defined between the first lavatory door and the first storage door.

In a preferred embodiment, in the closed position, the first storage door is latched to the second side wall, and in the open position the first storage door is latched to the front wall. Preferably, the lavatory monument assembly further includes a second storage compartment positioned in the first lavatory interior above the first storage compartment. The second storage compartment includes a second storage door that is movable between an open position and a closed position. In an embodiment, the second storage door is also latchable to the front wall when it is in the open position.

In a preferred embodiment, the first storage compartment includes a trolley storage space and a wheelchair storage space. Preferably, the enclosure defines a second lavatory interior and includes a divider wall that divides the enclosure into the first lavatory interior and the second lavatory interior. The second lavatory interior includes a toilet therein, and the enclosure includes a second lavatory door that is movable between a closed and an open position and provides access to the second lavatory interior. In a preferred embodiment, the divider wall includes a divider door that is movable between a closed position and an open position, and a vertically extending center post. The second lavatory door is hingedly connected to the center post, and the center post and the second lavatory door are slidable to a stowed position when the second lavatory door is in the open position.

In a preferred embodiment, the first lavatory includes a sink positioned in the top of a sink cabinet, and the urinal is positioned in the front of the sink cabinet. Preferably, the urinal faces transversely.

In accordance with another aspect of the present invention there is provided a method of storing at least a first item in an aircraft lavatory that includes a urinal and at least a first storage compartment having a first storage door therein. The method includes moving the first storage door from a closed position to an open position. In the open position, the first storage door divides the lavatory into a urinal space and a storage space, such that access to the urinal is blocked by the first storage door. The method further includes moving the first item through a storage corridor and into the first storage compartment, and moving the first storage door from the open position to the closed position.

In a preferred embodiment, the method includes unlatching the first storage door before moving the first storage door from the closed position to the open position, and latching the first storage door in the closed position. Preferably the method also includes moving a second item through the storage corridor and into the first storage compartment before closing the first storage door. Preferably, the first item is a wheelchair and the second item is a trolley.

In the present invention, generally, the divider wall positioned between the first and second lavatory spaces is removed or otherwise moved out of the way. At least one of the lavatory doors is then slid inboard or outboard (depending on lavatory positioning) to create a larger opening than a single door.

The door system of the present invention allows for two single lavatories within an aircraft monument to be converted into a single larger accessible lavatory for people with disabilities and families with small children. The door system includes first and second lavatory doors, a divider door, and a movable center post. Using a combination of mortise hinges and linear tracks, the system can be manipulated to collapse the divider door between the two lavatories and along with the center door and post slide the entire system out of the way to open the two smaller standard sized door openings into one larger wide door opening (e.g., 30″ in a preferred embodiment).

The present invention includes an integrated lavatory, urinal aircraft monument that provides space for trolley storage. The monument also includes doors, etc. for access to the storage compartments and lavatory spaces together with other necessary components for operation of a lavatory monument. FIGS. 29-34 show and describe the lavatory monument assembly installed within a Boeing737 Aircraft and FIG. 35 shows the lavatory monument assembly installed in an Airbus A320. However, this is only exemplary and not limiting. The lavatory monument can be used in other aircraft or other vehicles.

Typically in the aft section of the B737 there are 2 types of units: a galley (G4, G4B, or G4C) or a lavatory. In a preferred embodiment, the new lavatory monument is an integrated monument that is installed in the footprint of a standard aft lavatory. However, this is only exemplary and not a limitation on the present invention. The space required for the urinal is generally smaller than the space necessary for a standard toilet. The extra space provided by using the urinal instead of a toilet provides the ability to include at least a first or lower storage compartment.

The invention, together with additional features and advantages thereof, may be best understood by reference to the following description.

### BRIEF DESCRIPTION OF THE DRAWINGS

FIG. 1 shows an aircraft with a lavatory monument assembly disposed therein;

FIG. 2 is a perspective view of a lavatory monument assembly in accordance with a preferred embodiment of the present invention with the divider door in the closed position, the first lavatory door in the closed position and the second lavatory door in the closed position;

FIG. 3 is a perspective view of the lavatory monument assembly of FIG. 1 with the divider door in the closed position, the first lavatory door in the open position and the second lavatory door in the closed position;

FIG. 4 is a perspective view of the lavatory monument assembly of FIG. 1 with the divider door partially open, the first lavatory door in the open position and the second lavatory door in the closed position;

FIG. 5 is a perspective view of the lavatory monument assembly of FIG. 1 with the divider door in the open position, the first lavatory door in the open position and the second lavatory door in the closed position;

FIG. 6 is a cross-sectional perspective view taken along line 6-6 of FIG. 5;

FIG. 7 is a perspective view of the lavatory monument assembly of FIG. 1 with the first lavatory door in the open position and the second lavatory door partially open with the divider door secured thereto;

FIG. 8 is a perspective view of the lavatory monument assembly of FIG. 1 with the first lavatory door in the open position, the second lavatory door in the open position with the divider door secured thereto, and the center post in the home position;

FIG. 9 is a perspective view of the lavatory monument assembly of FIG. 1 with the first lavatory door in the open position and the second lavatory door, divider door and center post slid to the left;

FIG. 10 is a perspective view of the lavatory monument assembly of FIG. 1 with the first lavatory door in the open position and the second lavatory door, divider door and center post in the stowed position;

FIG. 11 is a perspective view of the lavatory monument assembly of FIG. 1 with the first lavatory door in the closed position, the second lavatory door in the closed position and the divider door in the open position;

FIG. 12 is a perspective view of a lavatory monument assembly in accordance with a another preferred embodiment of the present invention with the divider door in the closed position, the first lavatory door in the closed position and the second lavatory door in the closed position;

FIG. 13 is a perspective view of the lavatory monument assembly of FIG. 12 with the divider door in the closed position, the first lavatory door in the closed position and the second lavatory door in the open position;

FIG. 14 is a perspective view of the lavatory monument assembly of FIG. 12 with the divider door partially open, the first lavatory door in the closed position and the second lavatory door in the open position;

FIG. 15 is a perspective view of the lavatory monument assembly of FIG. 12 with the divider door in the open position, the first lavatory door in the closed position and the second lavatory door in the open position;

FIG. 16 is a perspective view of the lavatory monument assembly of FIG. 12 with the divider door in the open position, the first lavatory door partially open and the second lavatory door in the open position;

FIG. 17 is a perspective view of the lavatory monument assembly of FIG. 12 with the divider door in the open position, the first lavatory door in the open position and the second lavatory door and center post in the stowed position adjacent the first lavatory door;

FIG. 18 is a top plan view of the lavatory monument assembly of FIG. 12 in the combined lavatory configuration and showing a person in a wheelchair entering the front opening;

FIG. 19 is a top plan view of the lavatory monument assembly of FIG. 12 in the combined lavatory configuration and showing a person in a wheelchair positioning himself within the enclosure interior;

FIG. 20 is a top plan view of the lavatory monument assembly of FIG. 12 in the combined lavatory configuration and showing a person in a wheelchair positioned where they can move to the toilet;

FIG. 21 is a top plan view of the lavatory monument assembly of FIG. 12 in the combined lavatory configuration (with the first and second lavatory doors closed) and showing a person in a wheelchair positioned to use the lavatory;

FIG. 22 is a top plan view of a lavatory monument assembly in accordance with a another preferred embodiment of the present invention with the divider door in the closed position, the first lavatory door in the closed position and the second lavatory door in the closed position;

FIG. 23 is a top plan view of the lavatory monument assembly of FIG. 22 with the divider door in the open position, the first lavatory door in the open position and the second lavatory door in the open position;

FIG. 24 is a top plan view of the lavatory monument assembly of FIG. 22 with the first lavatory door in the open position and the center post in the home position with the divider door and the second lavatory door secured together;

FIG. 25 is a top plan view of the lavatory monument assembly of FIG. 22 in the combined lavatory configuration;

FIG. 26 is a top plan view of the lavatory monument assembly of FIG. 22 with the first lavatory door in the open position and the center post with the divider door and the second lavatory door secured together after being slid back to the home position;

FIG. 27 is a top plan view of the lavatory monument assembly of FIG. 22 with the divider door in the open position, the first lavatory door in the open position and the second lavatory door in the open position;

FIG. 28 is a top plan view of the lavatory monument assembly of FIG. 22 with the first and second lavatory doors closed, the divider door open and in the configuration where a PRM can use the lavatory;

FIG. 29 is a plan view of the aft portion of an aircraft that includes an aft monument in accordance with a preferred embodiment of the present invention showing a lavatory monument assembly together with a galley;

FIG. 30 is a plan view of the lavatory monument assembly of FIG. 29;

FIG. 31 is a front elevational view of the first lavatory of the lavatory monument assembly of FIG. 29 with the storage doors open;

FIG. 32 is a front elevational view of the first lavatory of the lavatory monument assembly of FIG. 29 with the storage doors closed;

FIG. 33 is a perspective view of the refresh center; and

FIG. 34 is a plan view of a lavatory monument assembly in accordance with another embodiment of the present invention.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an other embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” and “below” used herein are merely for ease of description and refer to the orientation of the components as shown in the figures. It should be understood that any orientation of the components described herein is within the scope of the present invention.

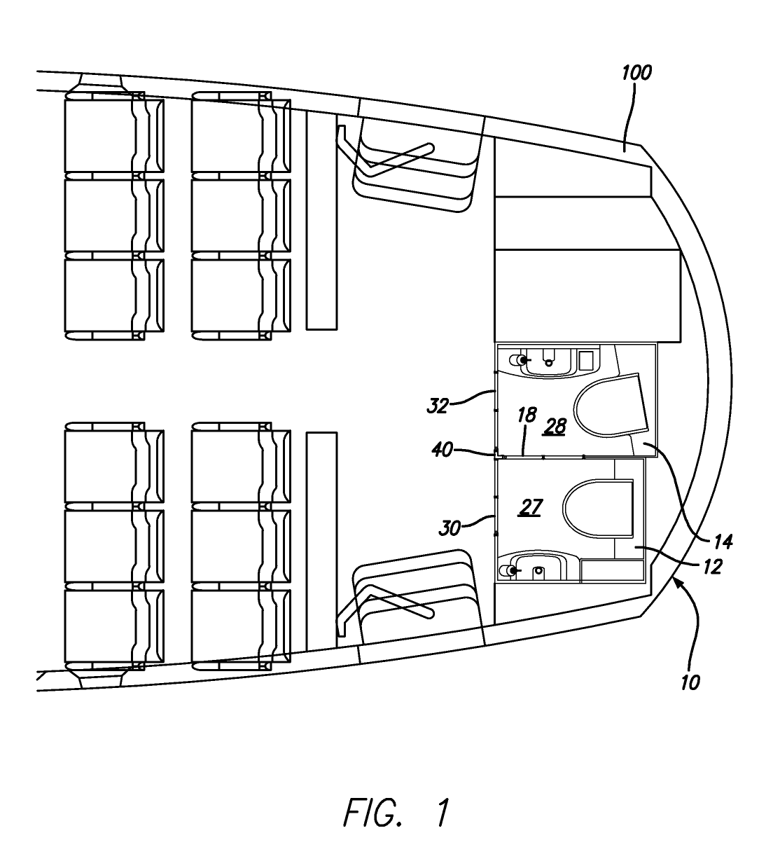

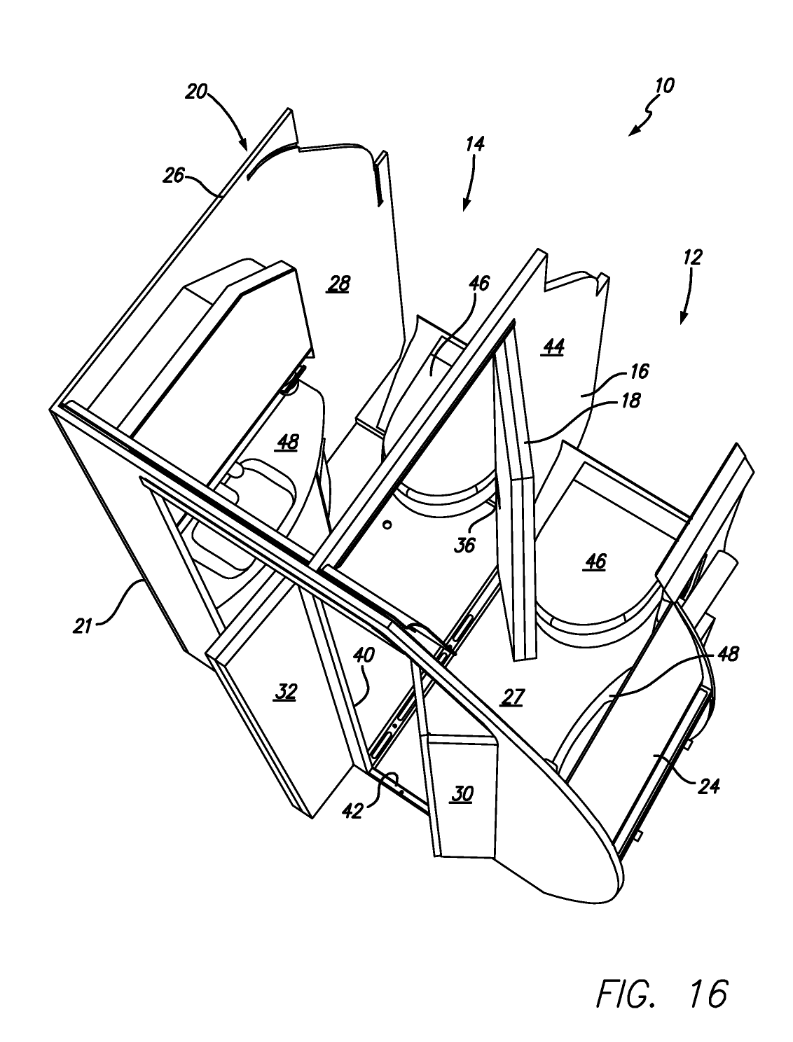

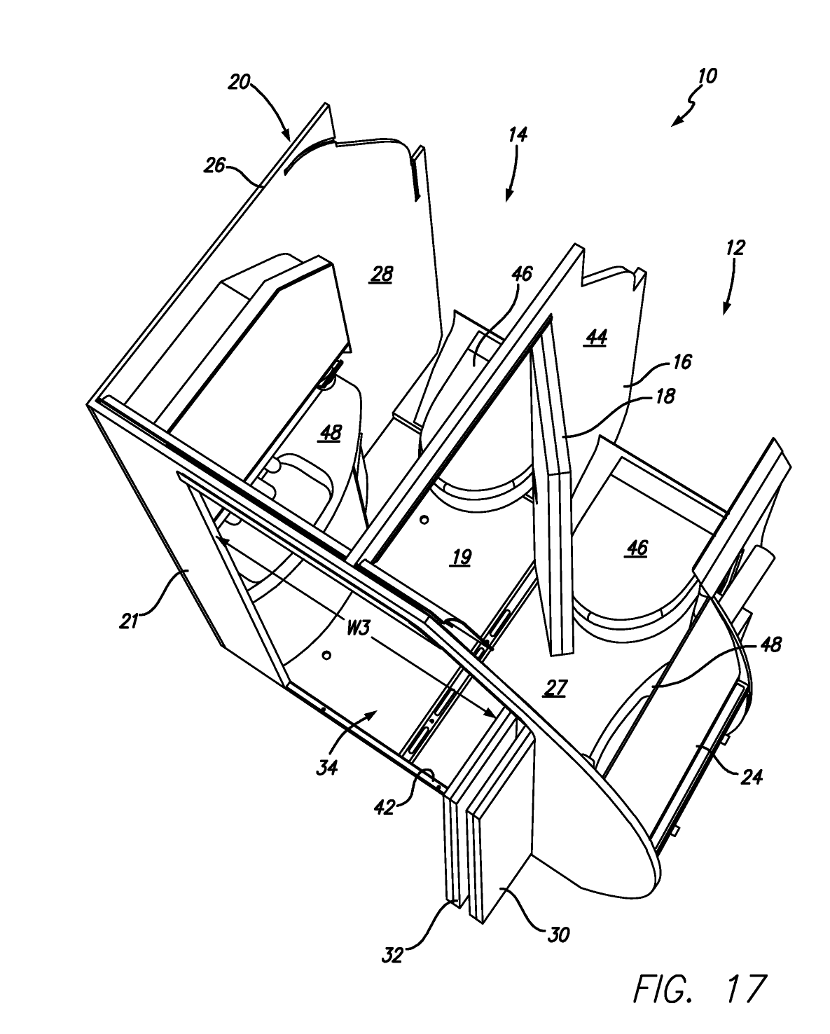

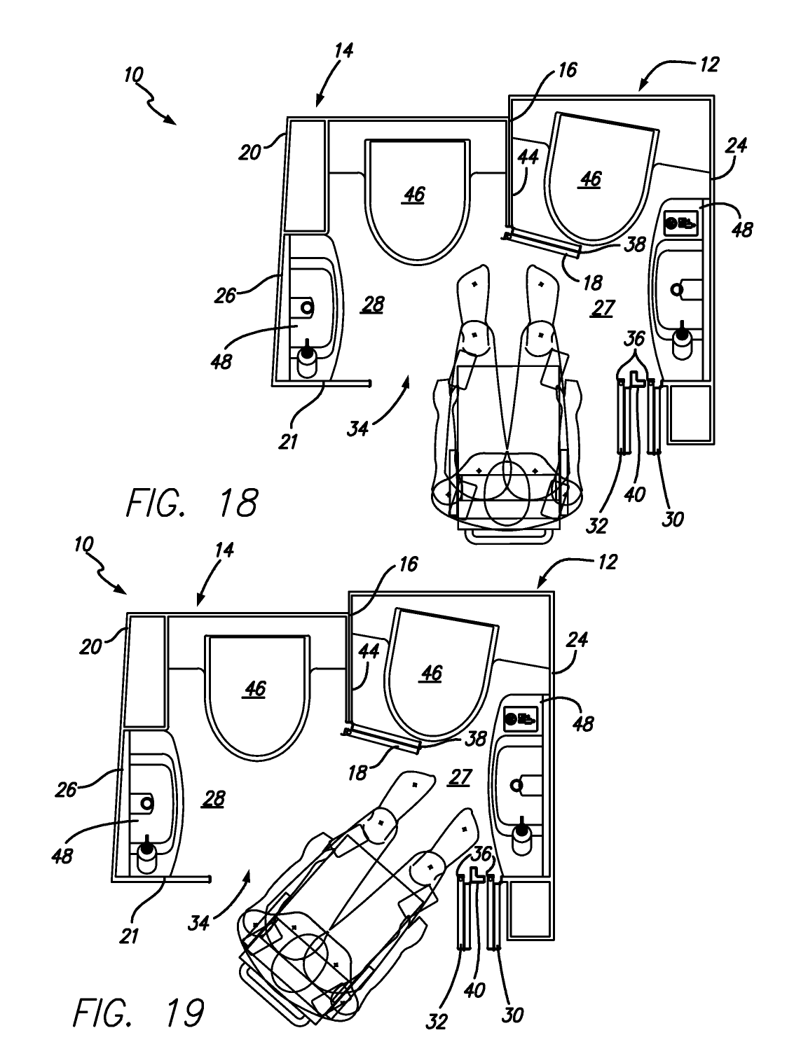

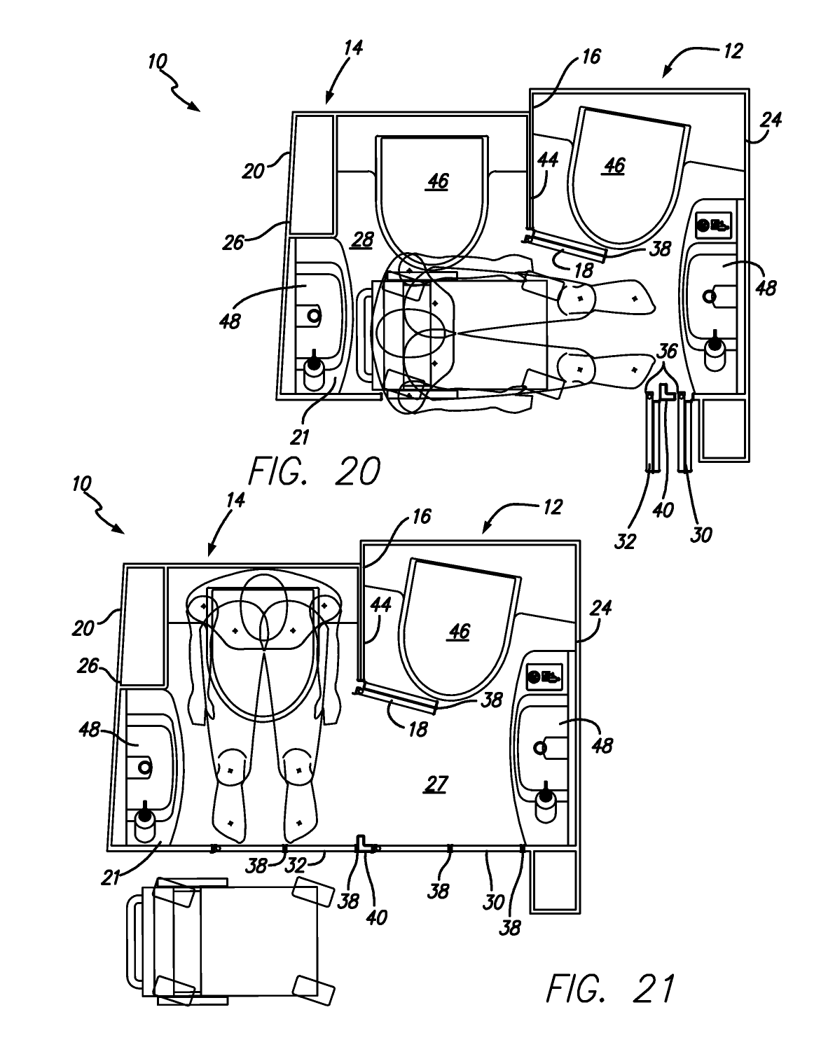

Referring now to the drawings, wherein the showings are for purposes of illustrating the present invention and not for purposes of limiting the same, FIGS. 1-21 show an embodiments of a lavatory monument assembly 10 that generally includes first and second lavatories 12 and 14 with a divider wall 16 there between and the ability to combine the two lavatory interior spaces by moving a divider door 18 to provide access for persons of reduced mobility (PRM) who are usually confined to a wheelchair.

In particular, the present invention is contemplated for use on commercial passenger aircraft 100, as shown in FIG. 1. However, this is not a limitation on the present invention and the lavatory assembly can be used elsewhere. The lavatory monument assembly 10 shown in the figures is configured to be positioned on the left or port side of an aircraft facing forward. However, it will be appreciated that a lavatory monument assembly that is a mirror image of the lavatory monument assembly 10 described herein and that is positioned on the right side of the aircraft facing forward is within the scope of the present invention. The lavatory monument assembly 10 can also be positioned such that it faces aft or such that it faces left or right when positioned within the aircraft. Any orientation or positioning of the aircraft is within the scope of the present invention.

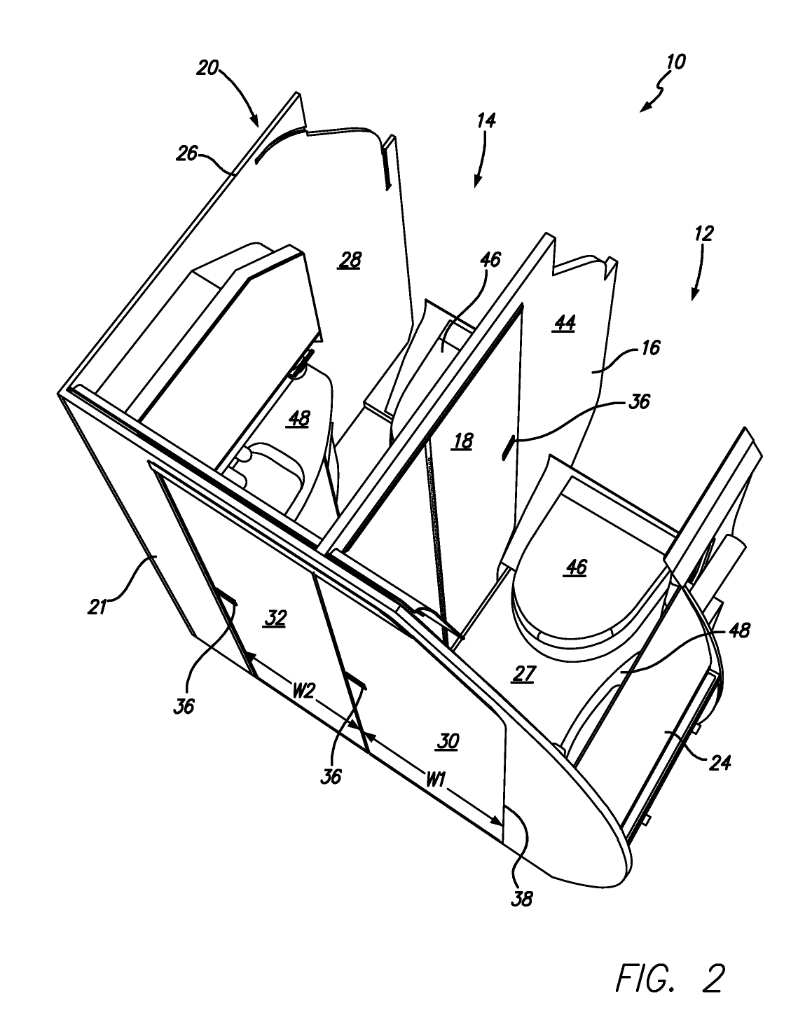

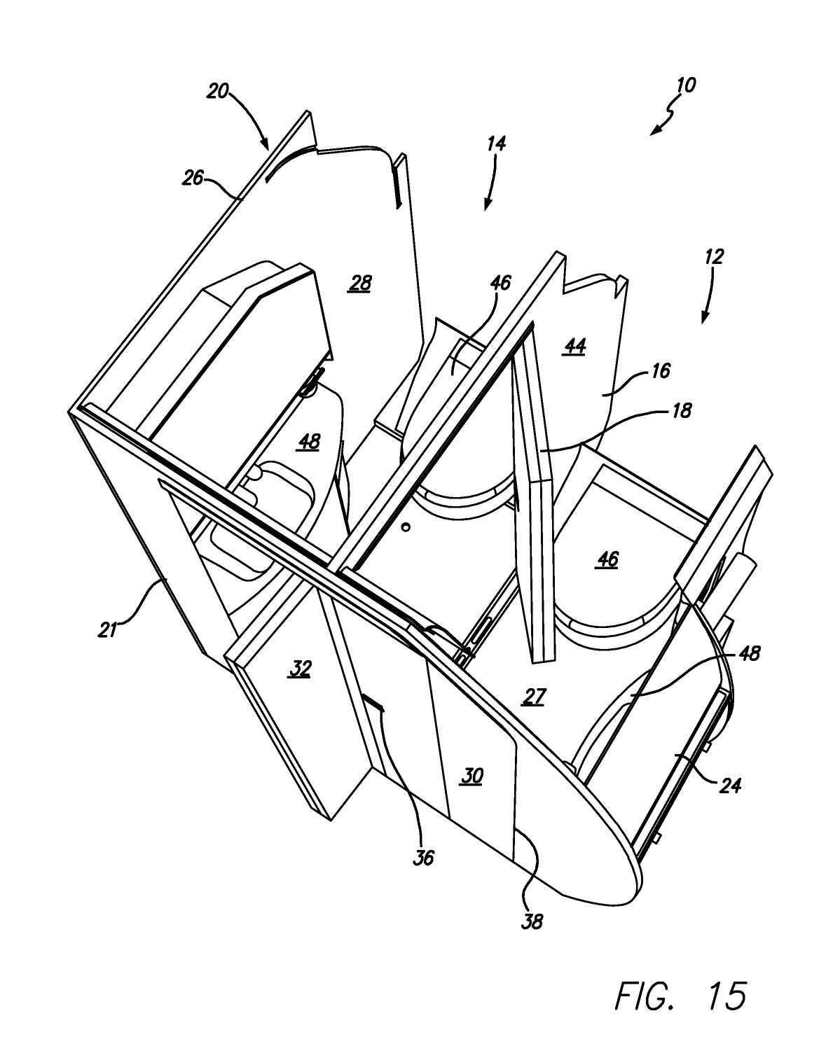

In a preferred embodiment, the lavatory monument assembly 10 comprises an enclosure 20 that includes a plurality of walls and defines an enclosure interior 19. In many of the figures (e.g., FIGS. 2-17) the rear wall of the enclosure 20 is omitted. However, it will be appreciated that when the lavatory monument assembly 10 is positioned in an aircraft a rear wall will be included whether it be an integral part of the enclosure 20 (as shown in FIGS. 18-21) or a separate wall (e.g., a wall of the aircraft). In general terms, the enclosure 20 includes a front wall 21, rear wall 22, and first and second side walls 24 and 26. The divider wall 16 extends between the front and rear walls 20 and 22 and includes the divider door 18, which is movable between a closed position and an open position, and, when in the closed position, divides the enclosure interior 19 into a first lavatory interior 27 and a second lavatory interior 28. The front wall 21 includes a first lavatory door 30 that is movable between an open and a closed position and provides access to the first lavatory interior 27 and a second lavatory door 32 that is movable between an open and a closed position and provides access to the second lavatory interior 28. It will be appreciated by those of skill in the art that the first and second lavatory doors 30 and 32 can be any type of door. For example, FIGS. 2-11 show the first and second lavatory doors 30 and 32 as single panel or blade doors and FIGS. 12-17 show the first and second lavatory doors 30 and 32 as double panel, bi-fold or flappy doors.

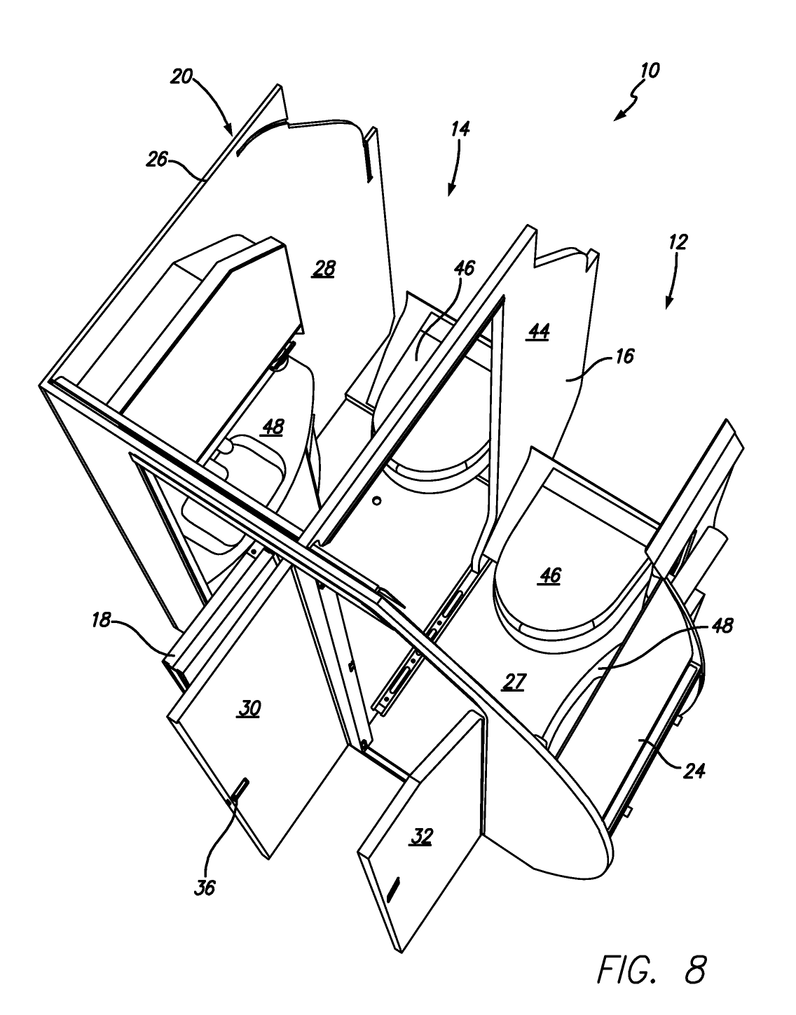

As is shown in FIGS. 2 and 12, when the divider door 18 is in the closed position, the first and second lavatories 12 and 14 are separate. In this configuration (the “separate lavatory” configuration), the first and second lavatories 12 and 14 are usable separately and the first lavatory 12 is accessible by the first lavatory door 30 and the second lavatory 14 is accessible by the second lavatory door 32. As is shown in FIGS. 9 and 17, when the divider door 18, first lavatory door 30 and second lavatory door 32 are all in the open position (the “combined lavatory” configuration), the opening 34 provided in the front wall 21 is large enough to provide access to a person in a wheelchair. To change from the separate lavatory configuration to the combined lavatory configuration each of the divider door 18, first lavatory door 30 and second lavatory door 32 are all moved from the closed position to the open position. This can be done in any desired order. More specific embodiments and process steps are provided below.

It will be appreciated that all of the doors include latches, handles and/or locks, etc. as are known in the art. For example, see latches 36 (or release bolt locks or the like) on all three of the doors in the figures. Furthermore, hinges are included where necessary to allow doors to open or fold, as desired. For example, see hinge 38 that allows the divider door 18 to fold, and hinges 38 that allow the first lavatory door 30, second lavatory door 32 and divider door 18 to open. A detailed description of the latches, locks, etc. are omitted as these components are known in the art.

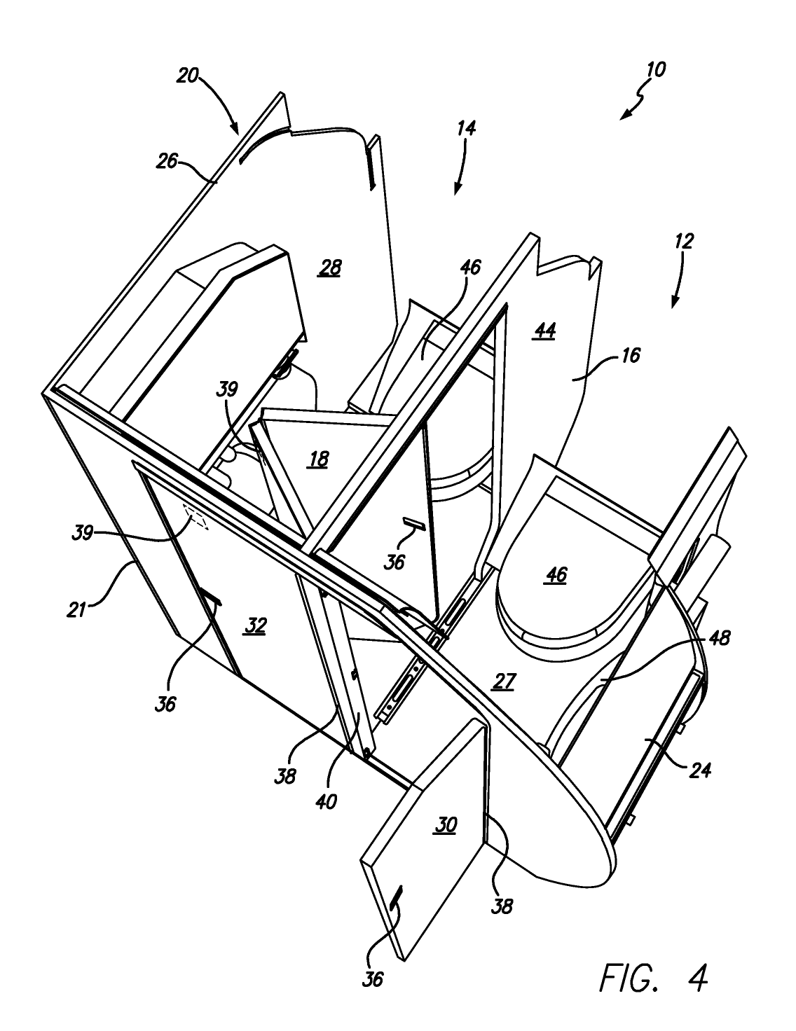

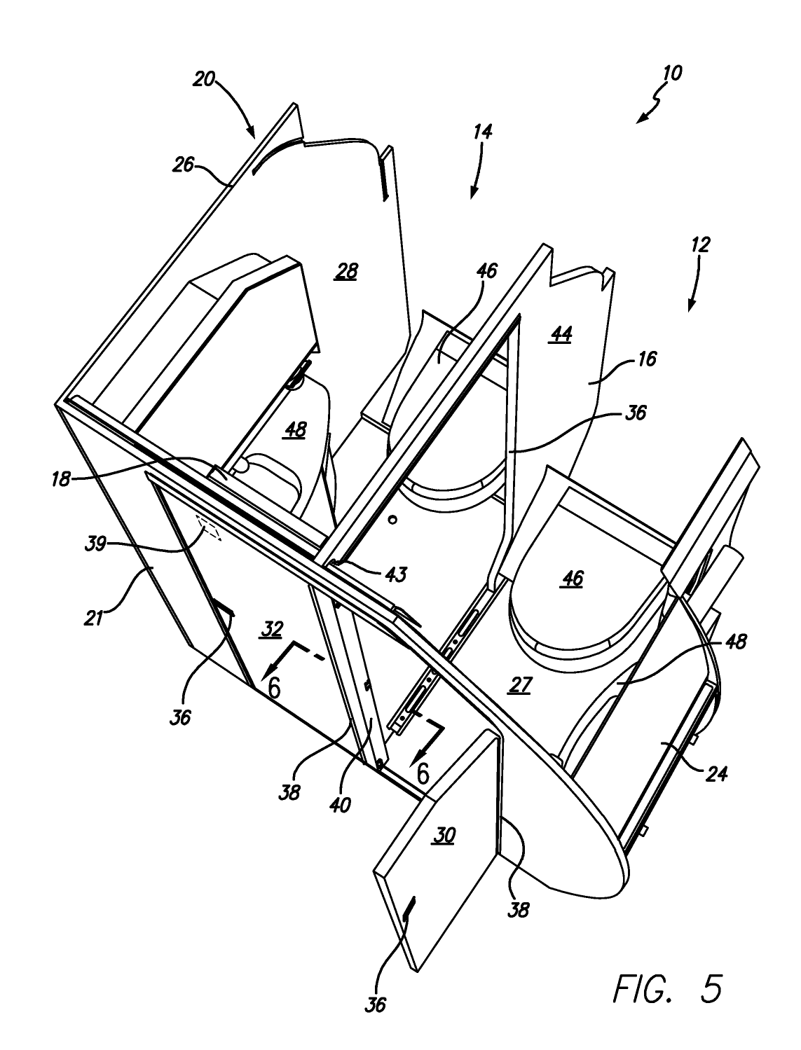

In a preferred embodiment, the divider door includes spring hinges so that when the divider door 18 is unlatched by a user it at least partially opens on its own. However, this is not a limitation on the present invention and a non-spring hinge can be used. Divider door 18 can be a bi-fold door as shown in the figures and can slide within a track or not. However, any type of door is within the scope of the present invention. For example, divider door 18 can be a blade door that is hinges open or slides into a recess. In a preferred embodiment components are included that secure divider door 18 to second lavatory door 32 in the configuration shown in FIGS. 5-11. For example, magnets, Velcro, latches, hooks, etc. can be used. FIG. 4 shows magnets 39 on the divider door 18 and the second door 32. It will be appreciated that the magnets 39 are strong enough to hold the divider door 18 against or adjacent to the second door 32 during operation, but also make it easy enough for a user to separate the divider door 18 from the second door 32 after using the lavatory.

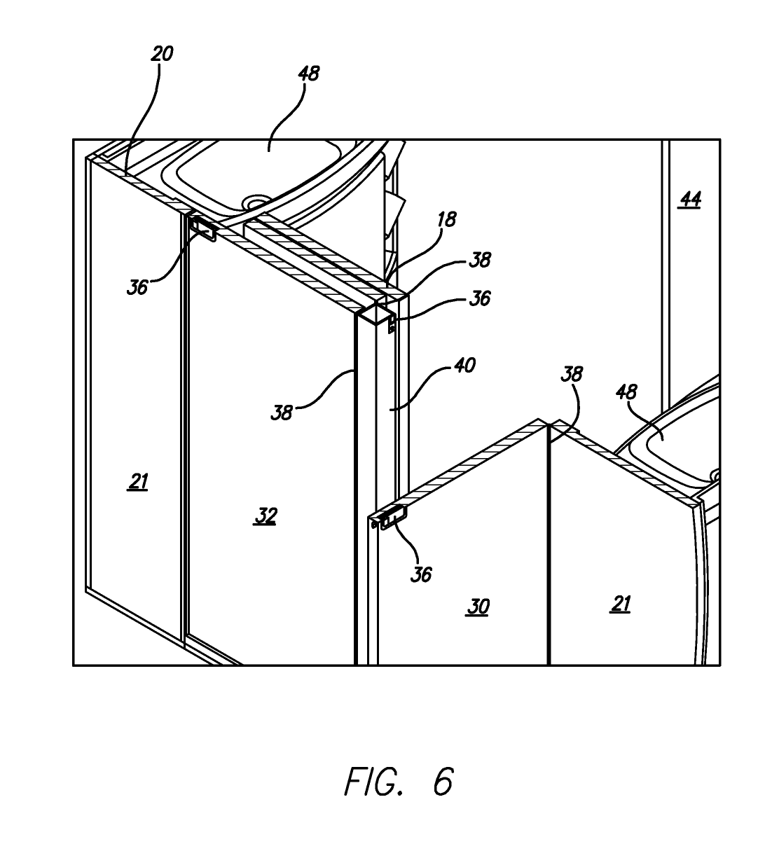

As shown in FIGS. 2-11, in a preferred embodiment, the front wall 21 also includes a vertically extending center post 40. As shown in FIG. 6, in a preferred embodiment, both the second lavatory door 32 and the divider door 18 are hingedly connected to the center post 40. The center post 40 preferably is slidable within tracks 42 at the top and bottom thresholds, as is shown in FIG. 9. Any type of track and associated roller, slider, glider, spring loaded post or the like is within the scope of the present invention. For example, in an embodiment, the door thresholds can include stainless steel rails. The top portion can include a nylon guider that is received in the rail and the bottom portion can include a nylon guider or an “I” shaped member that is received in the rail.

In a preferred embodiment, a latch or the like is located at the top or bottom of the center post 40 that allows a person using the lavatory to release the center post 40 so that they can slide it to the left (or right in another embodiment). Any type of latch or the like for securing the center post 40 during normal lavatory operation is within the scope of the present invention, e.g., a hook and keeper, spring loaded post, bolt latch, handle, switch, magnets, lever, bolt lock, Velcro, etc. As shown in FIG. 5, in a preferred embodiment, the lavatory monument assembly 10 includes a release 43 that is positioned on the center post 40 and extends upwardly to the divider wall 16 (or vice versa) that is movable between a latched and unlatched position. In the latched position the center post 40 cannot move in the tracks and in the unlatched position the center post 40 is slidable. In another embodiment, the release can be omitted and the center post 40 can be slidable once the divider door 18 is moved to the open position.

As shown in FIG. 9, in a preferred embodiment, because the second lavatory door 32 and divider door 18 are both hingedly connected to the center post 40 all three components slide together to a stowed position which, together with the open first lavatory door 30 provides a large opening 34 for a wheelchair to fit through. It will be understood that the center post 40 (and any components connected, secured or hinged thereto) is slidable between a home position and the stowed position.

The preferred embodiment shown in FIGS. 12-17, also includes a center post 40. However, in this embodiment, only the second lavatory door 32 is hingedly connected to the center post 40 as the divider door 18 folds toward the back of the enclosure 20 and is hingedly connected to a rear portion 44 of the divider wall 16. In another embodiment, the center post 40 can move with the first or second lavatory door 30 or 32 when the door is opened. In this embodiment, both doors open toward the outside of the enclosure 20.

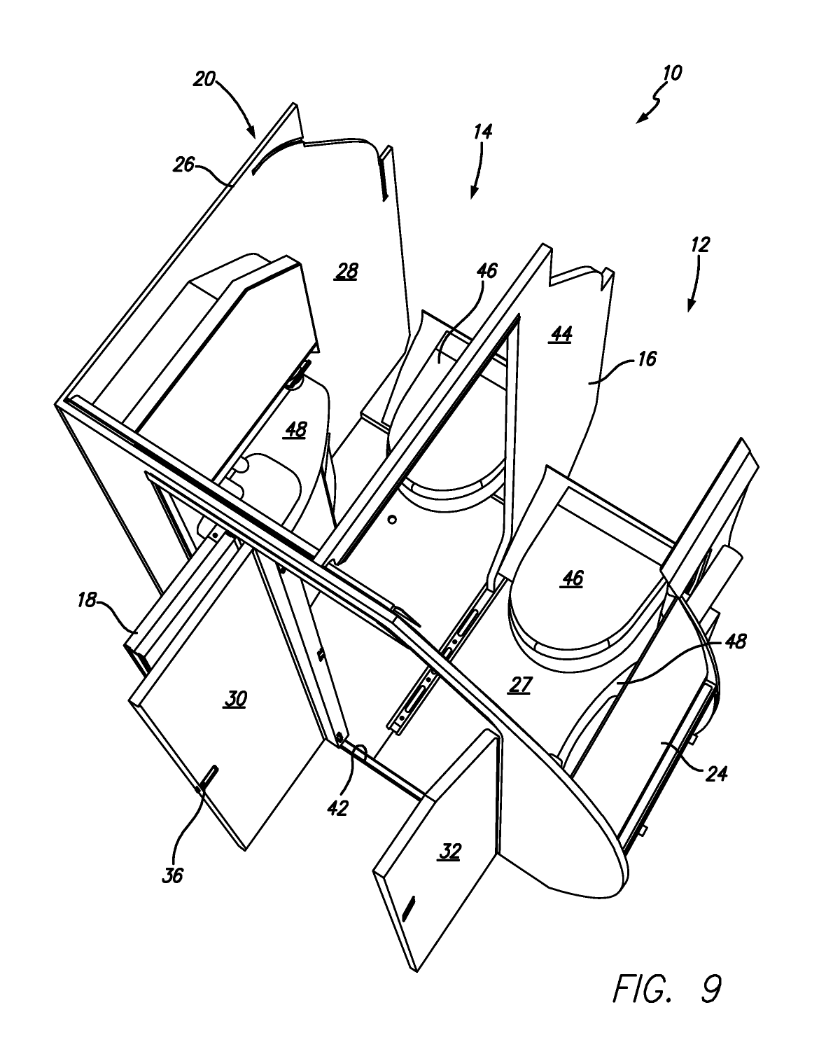

Generally, and as shown in FIGS. 2 and 12 the first lavatory door 30 defines a first width W1 and the second lavatory door 32 defines a second width W2. When the first and second lavatory doors 30 and 32 are in the open position, the opening 34 defines a third width W3 (as shown in FIGS. 10 and 17) that is larger than the first width W1 and is larger than the second width W2.

As shown in the figures, the lavatory monument assembly 10 preferably includes toilets 46, sinks 48 and other components typically present in aircraft lavatories. However, none of these components are limitations on the present invention. As shown best in FIGS. 18-21, in a preferred embodiment, the toilet 46 in the first lavatory is offset such that a line that bifurcates the toilet is not parallel to the side walls 24 and 26. However, this is not a limitation on the present invention.

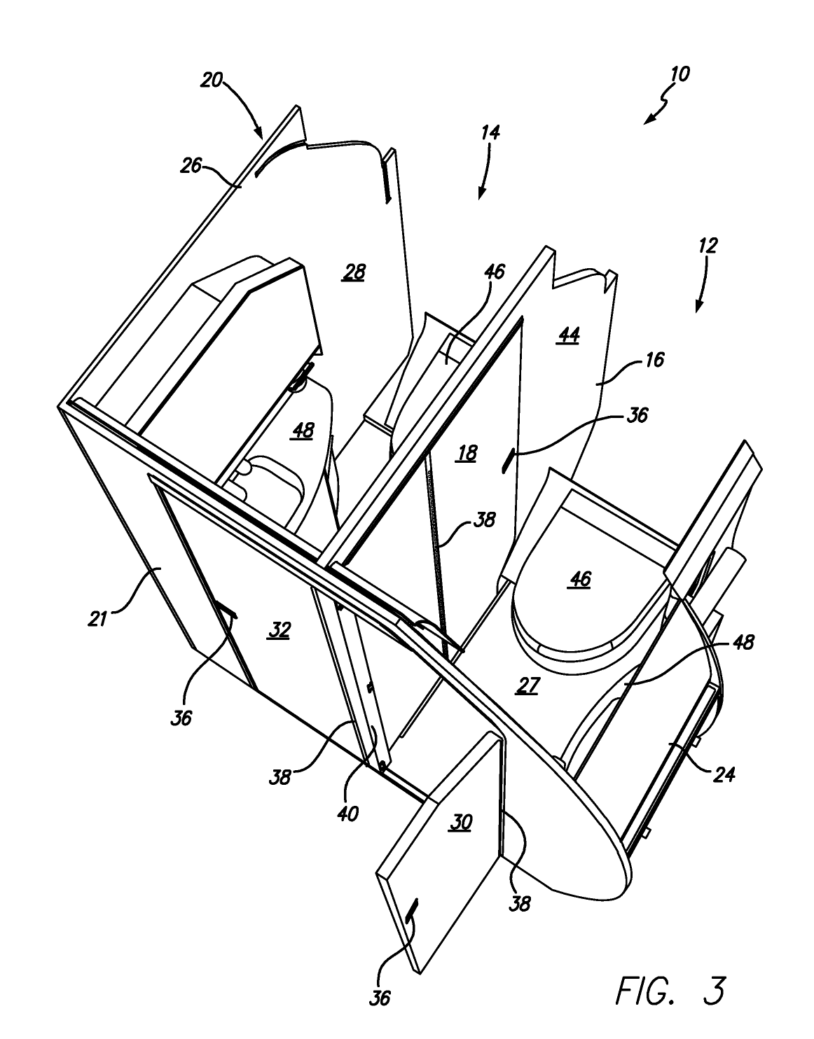

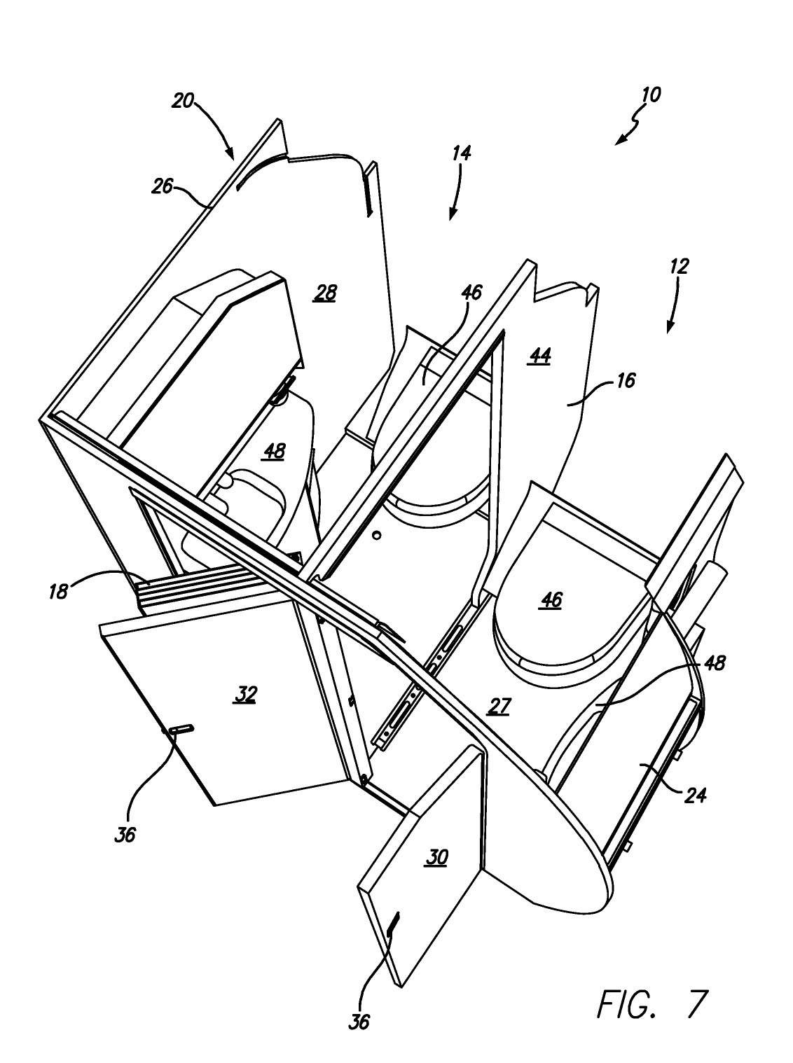

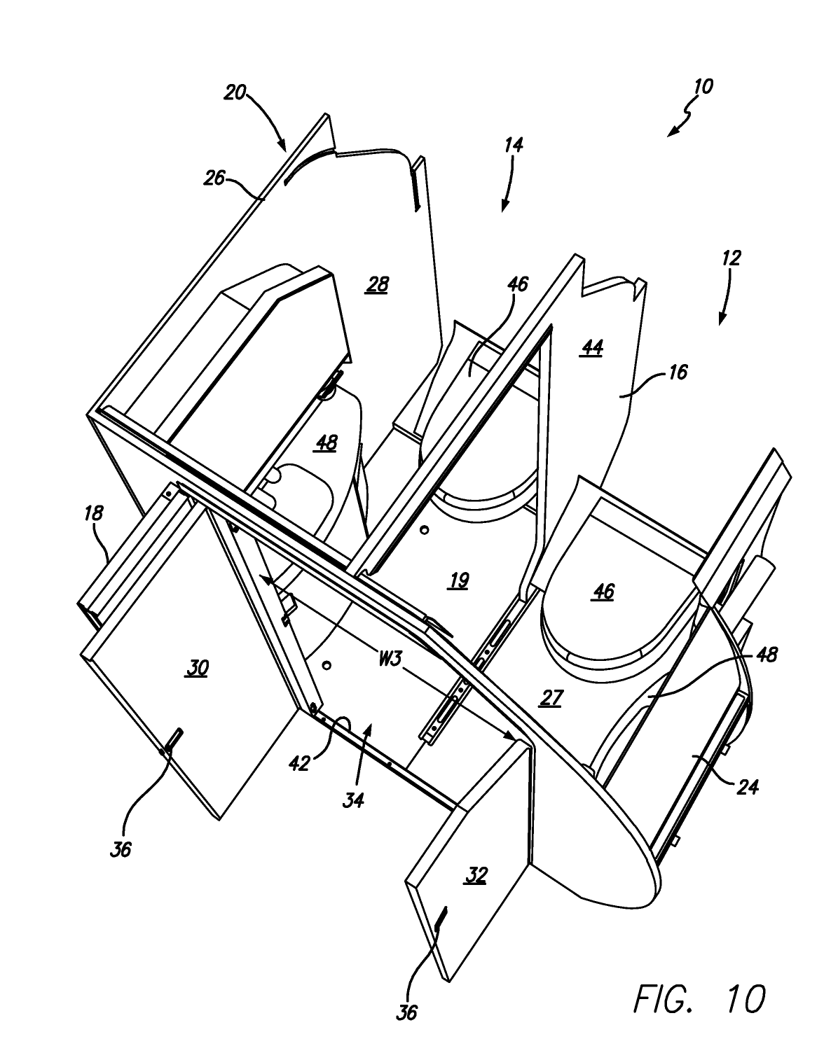

An exemplary method of using or operating the lavatory monument assembly 10 shown in FIGS. 2-11 will now be described. FIG. 2 shows the lavatory monument assembly with all the doors closed. The first lavatory door 30 is unlatched and opened, as is shown in FIG. 3. The divider door 18 is then unlatched and opened, as is shown in FIGS. 4 and 5. As is shown in FIG. 5, the divider door 18 is positioned against or adjacent second lavatory door 32. Next, the second lavatory door 32 is unlatched and opened together with the divider door 18, as shown in FIGS. 7-8. The center post 40 is then unlatched and slid to the left (inboard in this example), as is shown in FIG. 9, until it is reaches the stowed position, as is shown in FIG. 10. At this point, the PRM enters the enclosure interior 19, slides the center post 40 back to the home position and closes the first and second lavatory doors 30 and 32, as is shown in FIG. 11.

In another embodiment, bi-fold doors can be used for this same configuration (where the divider door 18 is hingedly connected to the center post 40). In another embodiment, in the stowed position (FIG. 10), the second lavatory door 32 can close to the right and the first and second lavatory doors 30 and 32 can be secured to one another. This prevents the PRM from having to slide the center post 40 back to the home position to use the lavatory. It will be appreciated that the latch 36 on the divider door 18 can be placed on the second lavatory side and the above method can be changed so that the second lavatory door 32 is opened first. In another embodiment, the divider door 18 can be unlatchable from both sides. In another embodiment, the divider door 18 is foldable toward the back of the enclosure 20 (similar to the embodiment shown in FIGS. 12-17).

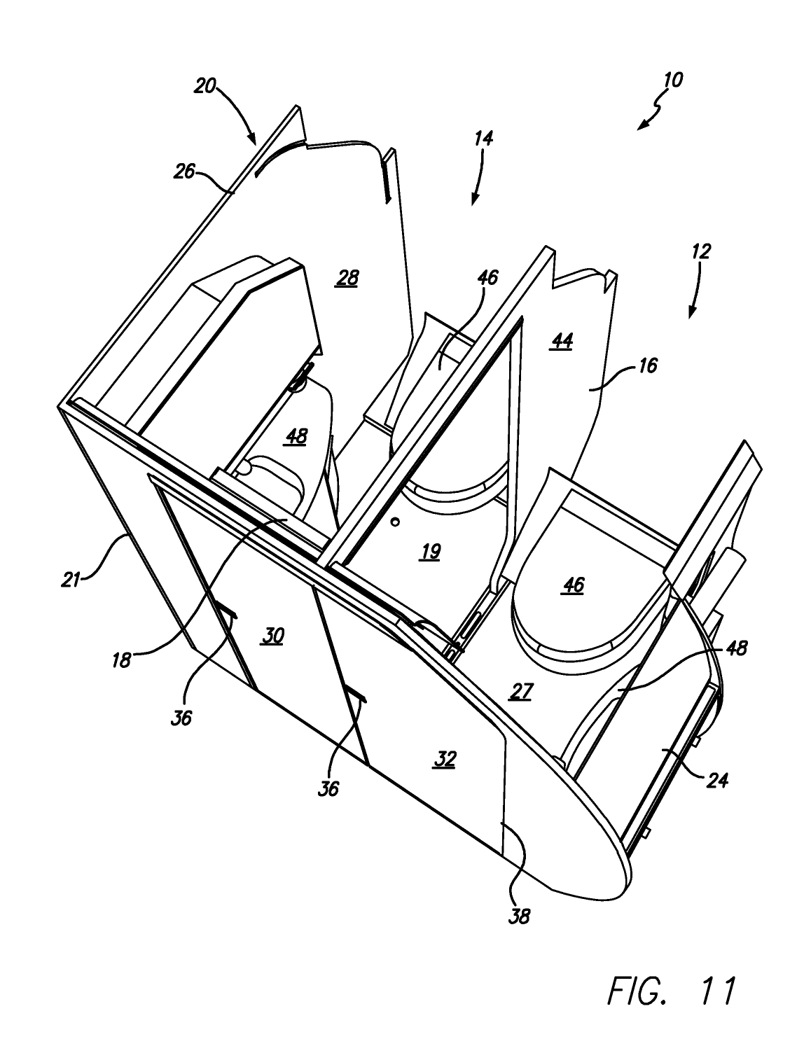

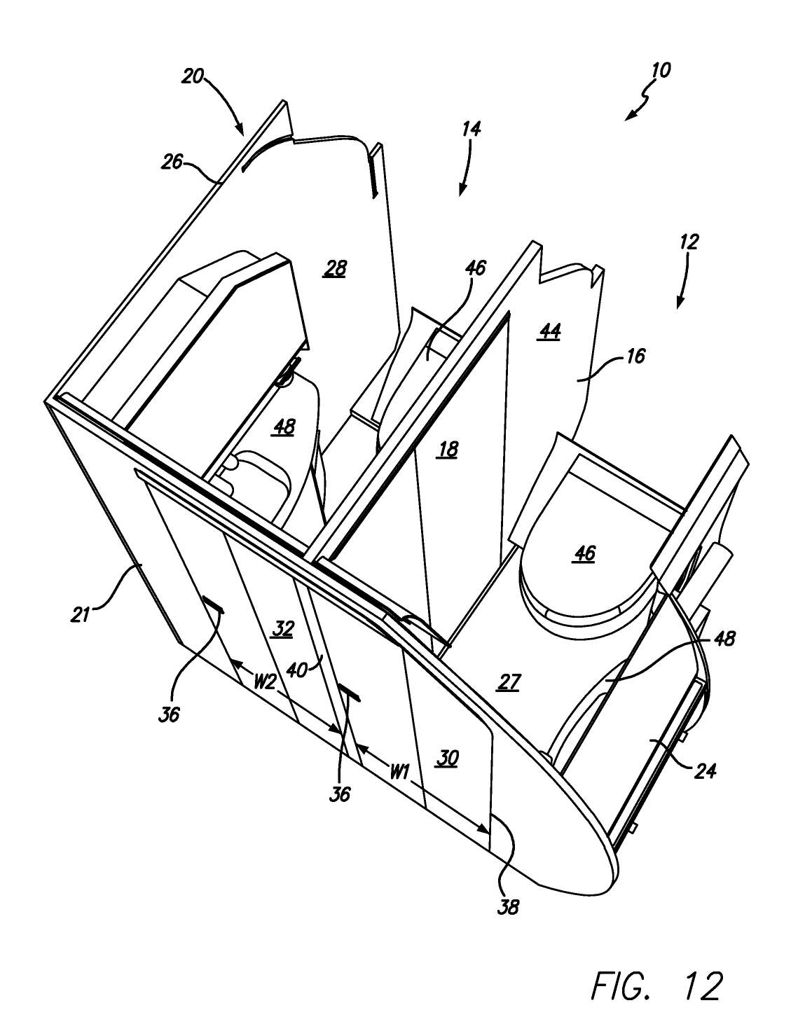

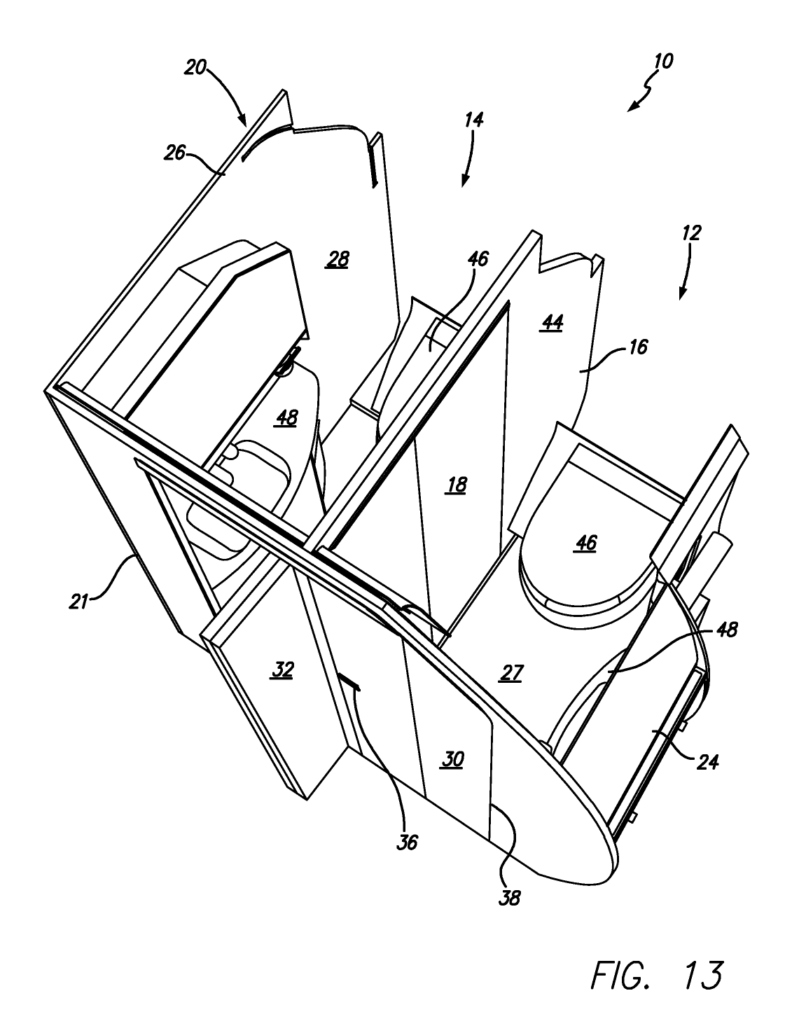

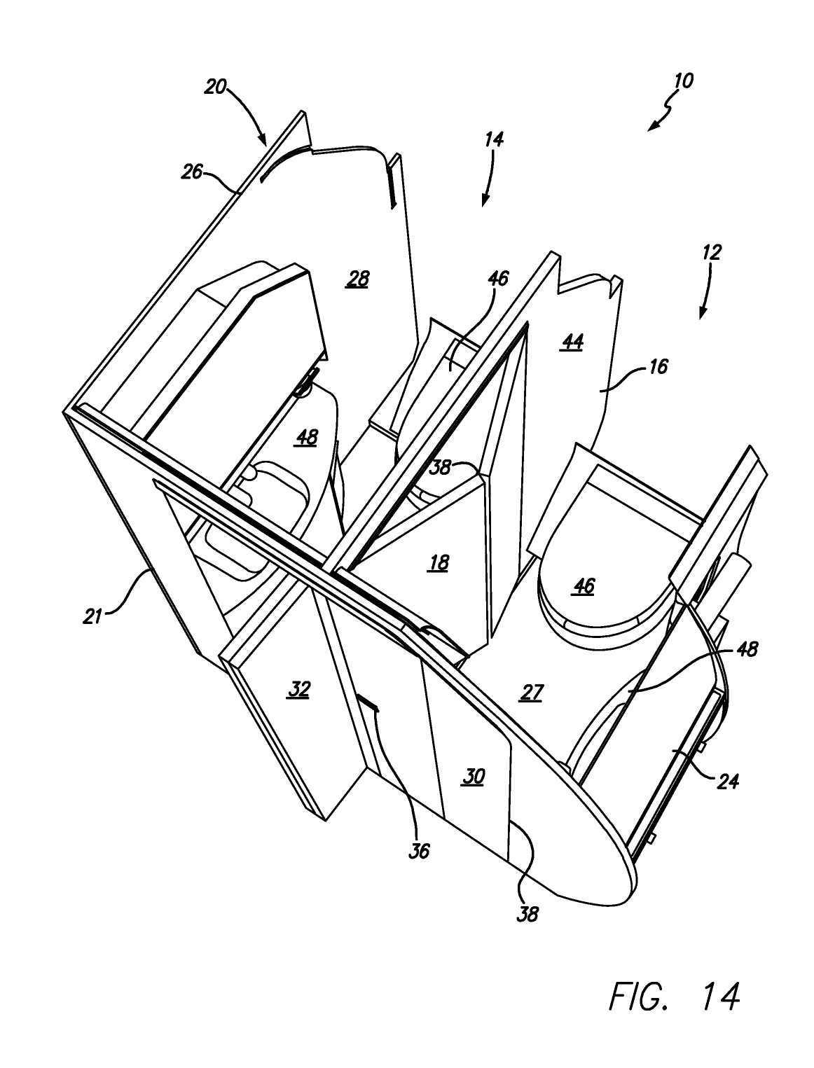

An exemplary method of using or operating the lavatory monument assembly 10 shown in FIGS. 12-17 will now be described. FIG. 12 shows the lavatory monument assembly with all the doors closed. The second lavatory door 32 is unlatched and opened, as is shown in FIG. 13. The divider door 18 is then unlatched and opened, as is shown in FIGS. 14-15. As is shown in FIG. 15, the divider door 18 is positioned against or adjacent the toilet 46 in the first lavatory 12. In a preferred embodiment components are included that hold the divider door 18 in this configuration. However, this is not a limitation on the present invention. Next, the first lavatory door 30 is unlatched and opened, as shown in FIG. 16. The center post 40 is then unlatched and slid to the right (outboard in this example) until it is reaches the stowed position, as is shown in FIG. 17. At this point, the PRM enters the enclosure interior 19, slides the center post 40 back to the home position and closes the first and second lavatory doors 30 and 32, as is shown in FIG. 21.

It will be appreciated that the latch 36 on the divider door 18 can be placed on the first lavatory side and the above method can be changed so that the first lavatory door 30 is opened first. In another embodiment, the divider door 18 can be unlatchable from both sides. In another embodiment, the divider door 18 is foldable toward the front of the enclosure 20 (similar to the embodiment shown in FIGS. 2-11).

In another embodiment, both the first and second lavatory doors 30 and 32 can be hinged to the center post 40 and can be slidable therewith. In yet another embodiment, the first and second lavatory doors 30 and 32 and the divider door 18 can all be hinged to the center post 40 and can be slidable therewith.

An exemplary method of a person using the lavatory monument assembly 10 in the combined lavatory configuration is shown in FIGS. 18-21. In a preferred embodiment, the person performs the methods described above to place the lavatory monument assembly 10 in the combined lavatory configuration, and then, as is shown maneuvers into the enclosure interior 19 exits the wheelchair, places the wheelchair outside the enclosure 20 and then closes the first and second lavatory doors 30 and 32 to use the lavatory.

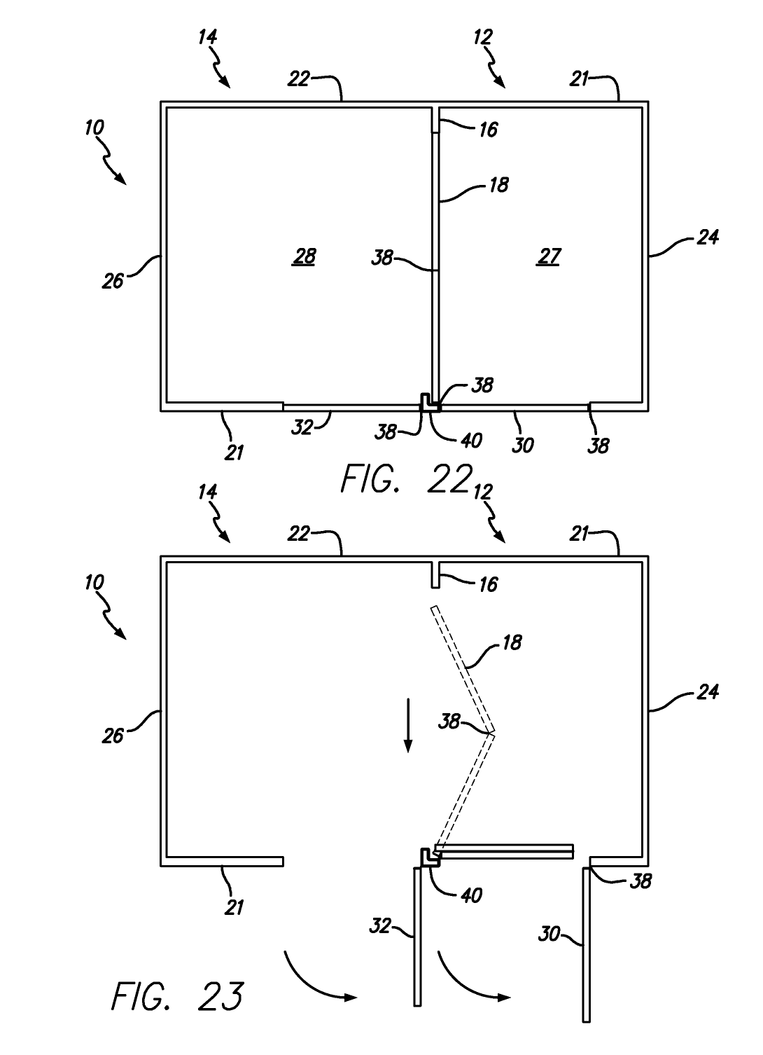

FIGS. 22-28 show another embodiment of a lavatory monument assembly 10 that includes a door system that opens to allow access for a PRM. In this embodiment, the second lavatory door 32 is positioned outboard and the first lavatory door 30 is positioned inboard in the aircraft. Also in this embodiment, the first and second lavatory doors 30 and 32 are blade doors and the divider door 18 is a bi-fold door. In a preferred embodiment, the first lavatory door 30 is hinged to the enclosure 20 (at the front wall 21) on the inboard side and opens inboard towards the center of the aircraft. The first lavatory door 30 can be any size and material. In an exemplary embodiment, the first lavatory door 30 is 19½″ and 74″ tall, is made of a ¾″ thick composite panel and is capped all around with aluminum u-shaped trims with the exception of a mortise hinge 38 on the inboard vertical edge.

The second lavatory door 32 is hinged to the center post 40 on the inboard side and opens inboard towards the center of the aircraft. In an exemplary embodiment, the second lavatory door 32 is 17½″ wide and 74″ tall, is made of a ¾″ thick composite panel and is capped all around with aluminum u-shaped trims with the exception of a mortise hinge 38 on the inboard vertical edge.

The divider door 18 is preferably positioned normal to the first and second lavatory doors 30 and 32 and is hinged at the center post 40 on the inboard side and when un-latched is spring loaded to collapse or fold towards the front wall 21. The bi-fold door includes two blades one forward and one aft that share a common mortise hinge 38. The forward blade.

In a preferred embodiment, the center post 40 is a structural beam that supports the second lavatory door 32 and the divider door 18. Generally, it provides a hinge location for the second lavatory door 32 and the divider door 18a and allows for the second lavatory door 32 and the divider door 18 to slide inboard in order to convert the first and second lavatories 12 and 14 into a single larger lavatory that is accessible by a disables person. In a preferred embodiment, the center post 40 is an L-Shaped post with integrated mortise hinges. The post can be made of, for example, an aluminum extrusion. In an exemplary embodiment, at the top of the center post 40 is attached a set of linear bearings that allow the center post 40 to slide inboard and outboard, and at the bottom of the center post 40 is a roller wheel guide that allows the center post 40 to move along the track 42.

An exemplary method of using or operating the lavatory monument assembly 10 shown in FIGS. 22-28 will now be described. FIG. 23 shows the lavatory monument assembly with all the doors closed. The second lavatory door 32 is unlatched and opened, as is shown in FIG. 23. In a preferred embodiment, components, such as a latch, lock, magnets, etc. are provided to secure the second lavatory door 32 in the open position. Next, the first lavatory door 30 is unlatched and opened, as is shown in FIG. 23. In a preferred embodiment, components, such as a latch, lock, magnets, etc. are provided to secure the first lavatory door 30 in the open position. The user now enters the enclosure interior 19 through the second lavatory door space and unlocks/unlatches the divider door 18. In another embodiment, the user can enter through the first lavatory door space if the latch 36 is provided on the opposite side of the divider door 18. The divider door 18 is then collapsed/folded in the forward direction until the two halves meet and are secured together (e.g., by a magnetic catch), as is shown in FIG. 23.

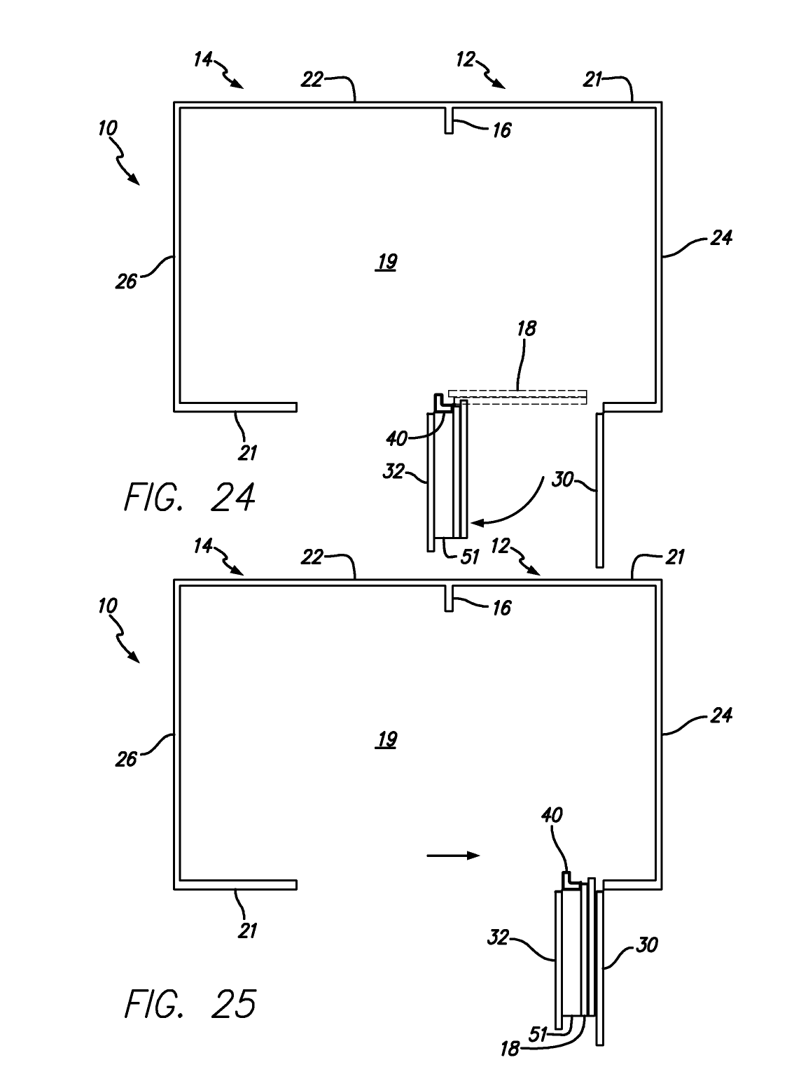

Once the divider door 18 halves are secured together and are normal to the flight direction, the divider door 18 is pivoted forward about the forward-most hinge 38 on the center post 40 until the two halves of the divider door 18 are parallel to the second lavatory door 32, as is shown in FIG. 24. In a preferred embodiment, a clasp 51 is provided to secure the divider door 18 to the second lavatory door 32 in the position shown in FIG. 24. However, this is not a limitation on the present invention.

Next, upper and lower slide locks, latches or releases 43 (see FIG. 5) are disengaged and the center post 40 (together with the divider door 18 and second lavatory door 32) are slid inboard toward the center of the aircraft from the home position to the stowed position, as is shown in FIG. 25. In a preferred embodiment, openings are the like are provided in the upper and lower door thresholds so that the upper and lower slide locks, latches or releases 43 can be inserted to lock the center post 40 in the stowed position. The upper and lower releases can be omitted or only an upper or only a lower release can be included.

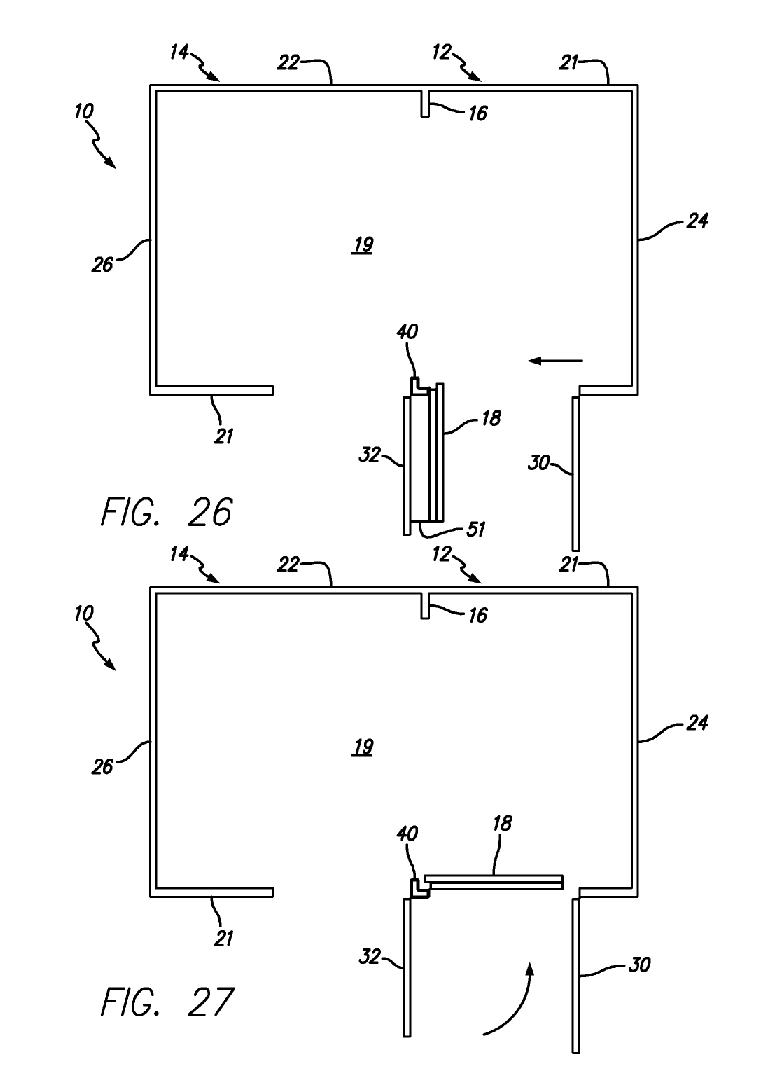

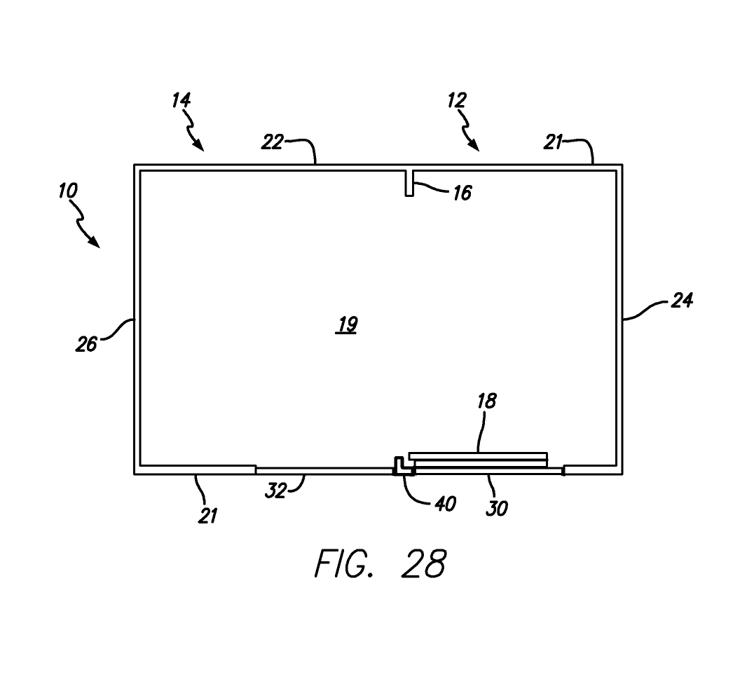

At this point in the process the opening 34 is now large enough to allow a PRM to enter with a wheelchair. Once the PRM has transferred from the wheelchair to the toilet seat, a flight attendant or other person can now close the doors as described below to give the PRM some privacy. First, the center post 40 (together with the divider door 18 and second lavatory door 32) are slid outboard to the home position, as shown in FIG. 26. The divider door 18 is then pivoted to the position shown in FIG. 27. A lock, latch, etc. can be provided to lock the divider door in this position. The first and second lavatory doors 30 and 32 are then closed, as shown in FIG. 28. It will be appreciated that the steps can be varied as desired. For example, the first lavatory door 30 can be opened after the divider door 18 has been opened. In another embodiment, the first and second lavatory doors 30 and 32 are bi-fold doors.

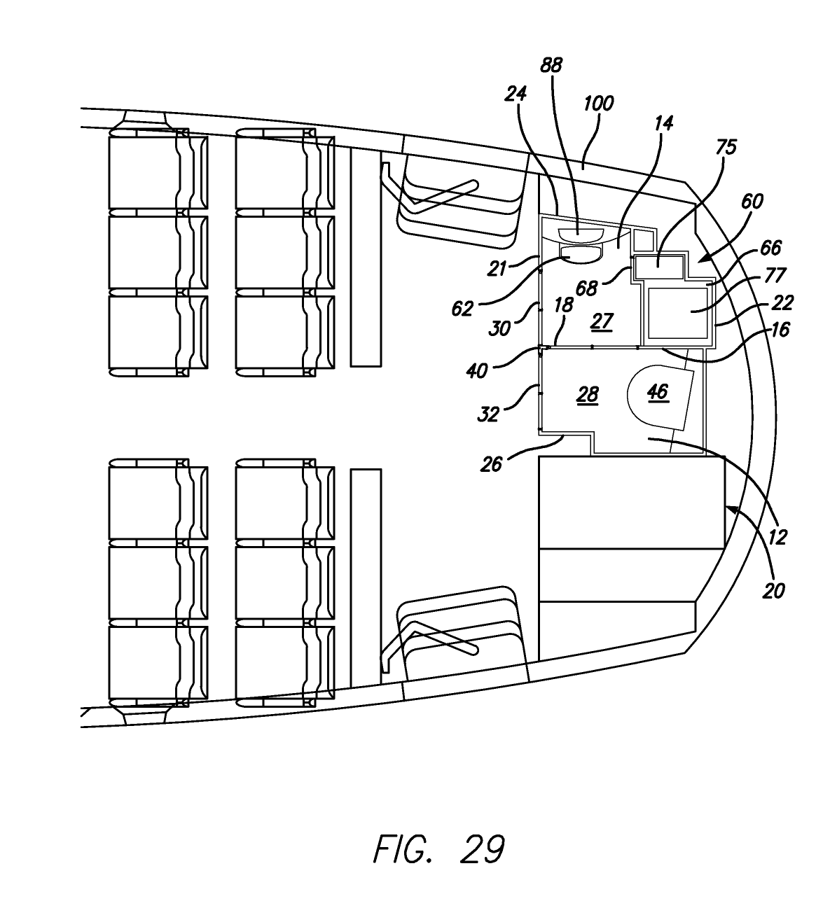

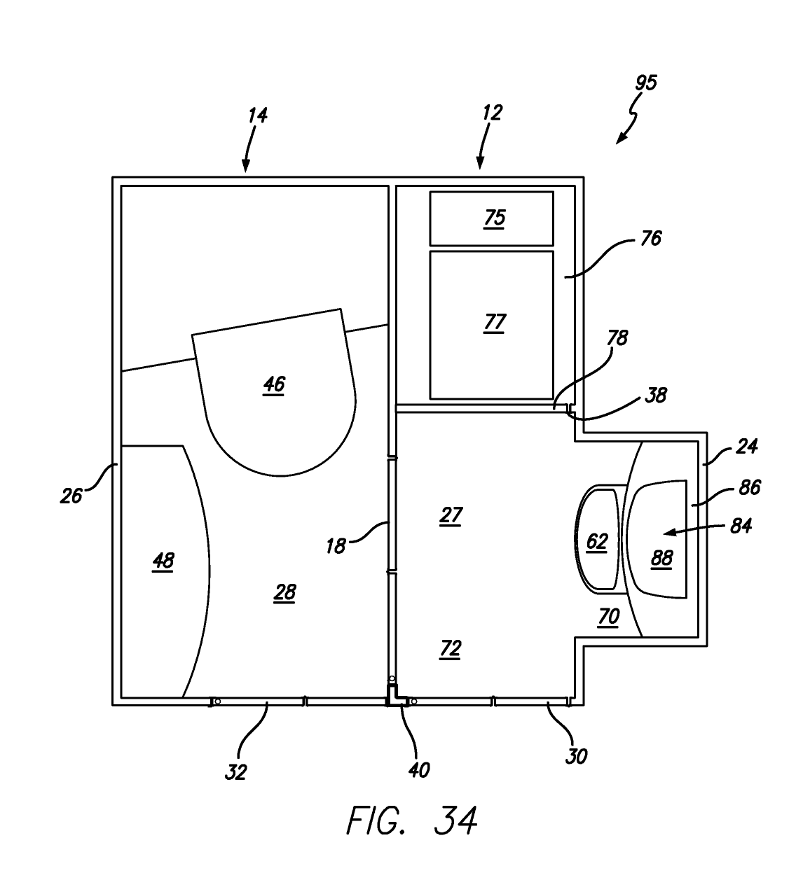

FIGS. 29-34 show another preferred embodiment of a lavatory monument assembly 60 installed in an aircraft. Similar to the lavatory monument assembly described above, the lavatory monument assembly 60 includes first and second lavatories 12 and 14 with a divider wall 16 therebetween and the ability to combine the two lavatory interior spaces by moving a divider door 18 to provide access for persons of reduced mobility who are usually confined to a wheelchair.

In general terms, the enclosure 20 includes a front wall 21, rear wall 22, and first and second side walls 24 and 26. The divider wall 16 extends between the front and rear walls 20 and 22 and includes the divider door 18, which is movable between a closed position and an open position, and, when in the closed position, divides the enclosure interior 19 into a first lavatory interior 27 and a second lavatory interior 28. The front wall 21 includes a first lavatory door 30 that is movable between an open and a closed position and provides access to the first lavatory interior 27 and a second lavatory door 32 that is movable between an open and a closed position and provides access to the second lavatory interior 28. It will be appreciated by those of skill in the art that the first and second lavatory doors 30 and 32 and the divider door 18 can be any type of door, e.g., a blade door or bi-fold door (as shown).

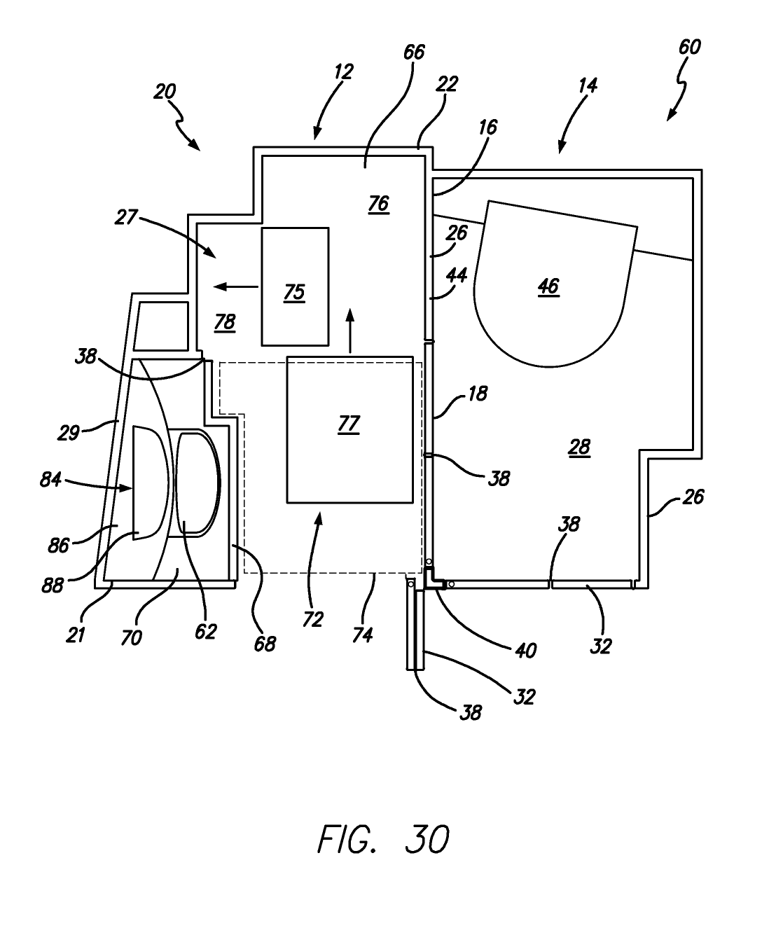

In a preferred embodiment, the first lavatory interior 27 includes a urinal 62 positioned therein and the second lavatory interior includes a toilet 46 positioned therein. In a preferred embodiment, the first lavatory interior 27 includes a first storage compartment 66 positioned therein that includes a first storage door 68 that is movable between an open position (FIG. 30) and a closed position (FIG. 29).

In a preferred embodiment, in the open position, the first storage door 68 blocks or seals off the urinal 62. In other words, in the open position, the first storage door 68 separates the first lavatory interior 27 into a urinal space 70 and a storage space 72. As shown in FIG. 30, the storage space 72 includes a storage corridor 74 and the first storage compartment 66. It will be appreciated by those of ordinary skill in the art that when items are placed in the storage compartment 66, the first storage door 68 blocks access to the urinal 62 and partially defines the storage corridor 74 so that items can move through the storage corridor 74 and into the first storage compartment 66. Therefore, the storage corridor 74 is defined between the first lavatory door 30 and the first storage door 68.

In a preferred embodiment, the first storage door 68 can be latched in both the closed position and the open position. Preferably, in the closed position, the first storage door 68 is latched to the divider wall 16 (or to the second wall in an embodiment with only one lavatory), and in the open position, the first storage door 68 is latched to the front wall 21. However, this is not a limitation on the present invention and an embodiment is possible where the first storage door 68 is only latchable in the closed position.

As shown in FIGS. 29-31, in a preferred embodiment of the present invention the first storage compartment 66 is sized and configured to receive a wheelchair 75 and a trolley 77. As shown in FIG. 30, the first storage compartment 66 can be configured to include a trolley storage space 76 and a wheelchair storage space 78. In FIG. 30, the wheelchair 75 is being moved into the wheelchair storage space 78 (see left facing arrow) and the trolley 77 is being moved through the storage corridor 74 (see the up facing arrow).

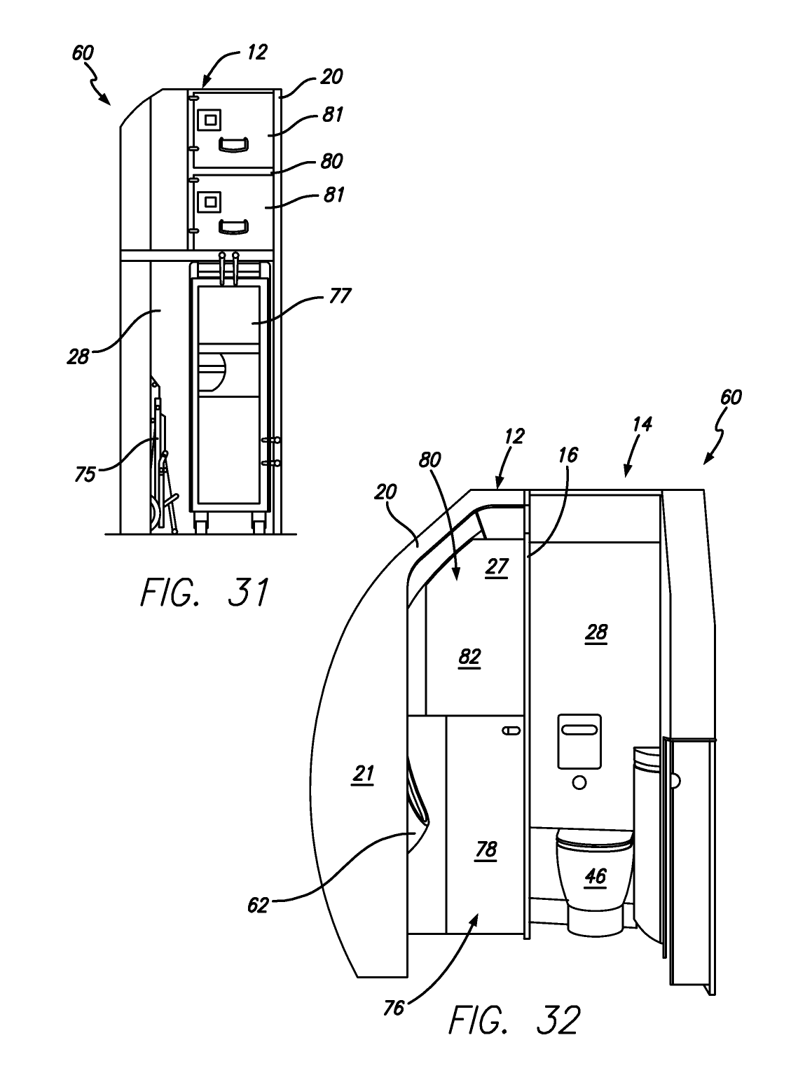

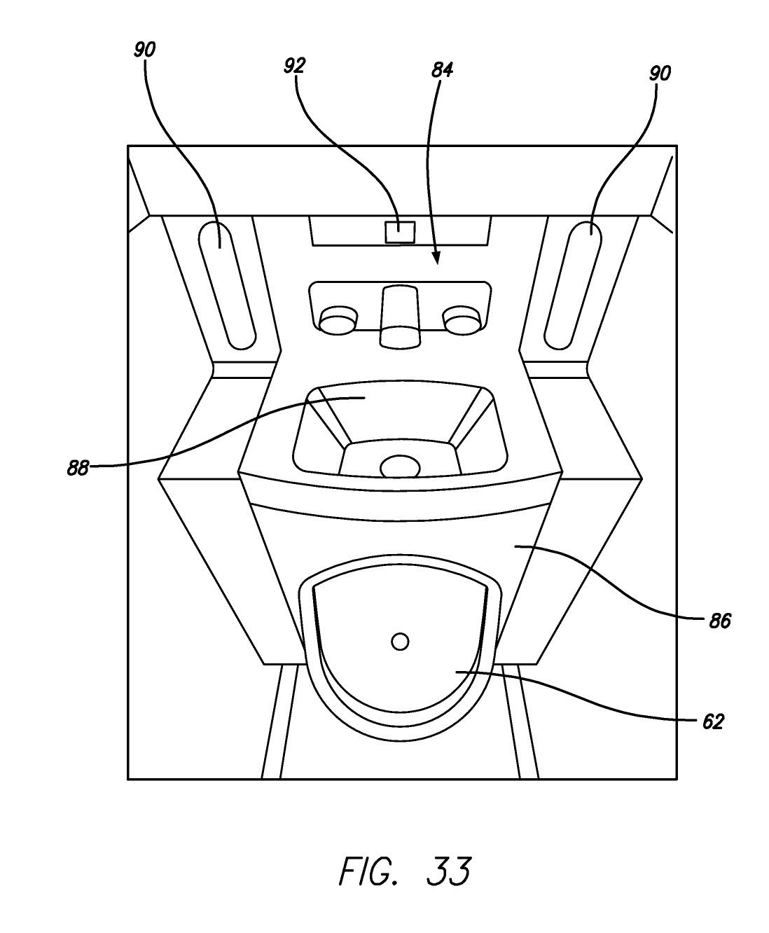

As shown in FIGS. 31-32, in a preferred embodiment, the first lavatory interior 27 includes a second storage compartment 80 that includes a second storage door 82 positioned therein. Preferably, the second storage compartment 80 is positioned above the first storage compartment 66. FIG. 31 shows the first storage compartment 66 with a ½ trolley 77 and a wheelchair 75 therein and the second storage compartment 80 with two standard units 81 therein. In a preferred embodiment, the second storage door 82 includes a mirror thereon.

As is best shown in FIG. 33, the urinal 62 is preferably part of a refresh center 84, which includes at least a sink cabinet 86 and a sink 88. Preferably, the urinal 62 is integrated into and/or positioned in front of the sink cabinet 86. The refresh center 84 can include a number of different amenities and components. For example, as shown in FIG. 33, the refresh center 84 can include lighting 90 and a flight attendant call button 92.

In a preferred embodiment, the toilet 46 in the second lavatory interior 28 is positioned at approximately a ten degree offset from the standard perpendicular location. Any angled offset is with the scope of the invention. The offset gives a passenger increased shoulder space compared to a toilet having no offset. In another embodiment, the toilet can have no offset.

Essentially, the first and second storage compartments 66 and 80 provide a galley within a lavatory. Other items can be stored within the storage compartments. For example, in another embodiment items that are typically used in the lavatory can be stored in the storage compartments. However, it is also contemplated that items that are not typically used in a lavatory can be stored in the storage compartments (e.g., the trolley, wheelchair and standard units).

It will be appreciated that the lavatory with the urinal 62 and the first storage compartment 66 can be provided or installed in a vehicle or aircraft without a second lavatory.

The present invention also includes a method of storing items within a lavatory. The method includes opening the first lavatory door 30, opening the first storage door 68, such that the urinal 62 is blocked, placing items to be stored in the first storage compartment 66 and then closing the first storage door 68. In a preferred embodiment, the method includes unlatching the first storage door 68 when it is in the closed position and then latching it when it is in the open position.

FIG. 35 shows a preferred embodiment of a lavatory monument assembly 95 that is similar to lavatory monument assembly 60, but that is positioned on the opposite side of the enclosure 20 (and aircraft). This embodiment also shows a slightly different configuration of the first storage door 68. However, the first storage door 68 is still capable of blocking access to the urinal 62. Furthermore, the first storage compartment 66 is configured to provide storage of the trolley 77 and wheelchair 75 in a fore and aft configuration instead of side-by-side.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed, at different times. Further any specific numbers noted herein are only examples: alternative implementations may employ differing values or ranges.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize Further, any specific numbers noted herein are only examples: alternative implementations may employ differing values, measurements or ranges. It will be appreciated that any dimensions given herein are only examplary and that none of the dimensions or descriptions are limiting on the present invention.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A lavatory monument assembly configured to be positioned in the interior of a vehicle, the lavatory monument assembly comprising:
an enclosure that defines a first lavatory interior and includes at least a front wall and first and second side walls extending rearwardly from the front wall,
wherein the first lavatory interior includes a urinal positioned therein,
a first storage compartment positioned in the first lavatory interior, wherein the first storage compartment includes a first storage door that is movable between an open position and a closed position, and
wherein the front wall comprises a first lavatory door that is movable between a closed and an open position and provides access to the first lavatory interior.

2. The lavatory monument assembly of claim 1 wherein in the open position, the first storage door separates the first lavatory interior into a urinal space and a storage space.

3. The lavatory monument assembly of claim 2 wherein the storage space comprises a storage corridor and the first storage compartment.

4. The lavatory monument assembly of claim 3 wherein the storage corridor is defined between the first lavatory door and the first storage door.

5. The lavatory monument assembly of claim 4 wherein in the closed position the first storage door is latched to the second side wall, and in the open position the first storage door is latched to the front wall.

6. The lavatory monument assembly of claim 5 further comprising a second storage compartment positioned in the first lavatory interior above the first storage compartment, wherein the second storage compartment includes a second storage door that is movable between an open position and a closed position.

7. The lavatory monument assembly of claim 1 wherein the first storage compartment includes a trolley storage space and a wheelchair storage space.

8. The lavatory monument assembly of claim 6 wherein the enclosure defines a second lavatory interior and includes a divider wall that divides the enclosure into the first lavatory interior and the second lavatory interior, wherein the second lavatory interior includes a toilet therein, and wherein the enclosure includes a second lavatory door that is movable between a closed and an open position and provides access to the second lavatory interior.

9. The lavatory monument assembly of claim 8 wherein the divider wall includes a divider door that is movable between a closed position and an open position, and a vertically extending center post, wherein the second lavatory door is hingedly connected to the center post, and wherein the center post and the second lavatory door are slidable to a stowed position when the second lavatory door is in the open position.

10. The lavatory monument assembly of claim 1 wherein the first lavatory includes a sink positioned in the top of a sink cabinet, and wherein the urinal is positioned in the front of the sink cabinet.

11. The lavatory monument assembly of claim 10 wherein the urinal faces transversely.

12. A method of storing at least a first item in an aircraft lavatory that includes a urinal and at least a first storage compartment having a first storage door therein, the method comprising the steps of
(a) moving the first storage door from a closed position to an open position, wherein in the open position the first storage door divides the lavatory into a urinal space and a storage space, whereby access to the urinal is blocked by the first storage door,
(b) moving the first item through a storage corridor and into the first storage compartment, and
(c) moving the first storage door from the open position to the closed position.

13. The method of claim 12 wherein step (a) includes unlatching the first storage door before moving the first storage door from the closed position to the open position, and wherein the first storage door is latched in the closed position.

14. The method of claim 13 further comprising the step of moving a second item through the storage corridor and into the first storage compartment prior to step (c), wherein the first item is a wheelchair and the second item is a trolley.
